(19) United States
(12) Patent Application Publication
(10) Pub. No.: US 2022/0192184 A1
(43) Pub. Date: Jun. 23, 2022

(54) FORMULATION

(71) Applicant: SYNGENTA CROP PROTECTION AG, Basel (CH)

(72) Inventor: Thomas SCHULTZ, Bracknell, Berkshire (GB)

(73) Assignee: SYNGENTA CROP PROTECTION AG, Basel (CH)

(21) Appl. No.: 17/432,693

(22) PCT Filed: Feb. 4, 2020
(86) PCT No.: PCT/EP2020/052725

§ 371 Date: Aug. 20, 2021

(30) Foreign Application Priority Data
Feb. 26, 2019 (GB) 1902551.9

(51) Int. Cl. A01N 25/04; A01N 33/12; A01N 37/42; A01N 43/40

(52) U.S. Cl. CPC A01N 25/04; A01N 43/40; A01N 37/42; A01N 33/12

(57) ABSTRACT

This invention relates to an emulsion comprising (i) an aqueous phase comprising an agrochemical A; and (ii) an oil phase comprising an agrochemical B; where either phase (i) is dispersed in phase (ii); or phase (ii) is dispersed in phase (i); agrochemical A is selected from salts of mepiquat and salts of chlormequat and mixtures of such salts; agrochemical B is trinexapac-ethyl; provided that the emulsion is not a microemulsion. It also relates to such an emulsion which is a ready mix emulsion; to use of such an emulsion for regulating plant growth; and to use of such an emulsion for preventing and/or reducing lodging of crop plants.

This invention relates to an emulsion comprising
an aqueous phase comprising an agrochemical A; and
(ii) an oil phase comprising an agrochemical B;
   where either phase (i) is dispersed in phase (ii); or phase (ii) is dispersed in phase (i); agrochemical A is selected from salts of mepiquat and salts of chlormequat and mixtures of such salts; agrochemical B is trinexapac-ethyl; provided that the emulsion is not a microemulsion. It also relates to such an emulsion which is a ready mix emulsion; to use of such an emulsion for regulating plant growth; and to use of such an emulsion for preventing and/or reducing lodging of crop plants.

WO2015/075646A1 discloses a ready mix microemulsion comprising trinexapacethyl and chloromequat chloride. However, it has been found that in such microemulsions, the trinexapac-ethyl displays poor chemical stability and may decompose significantly during storage tests; the skilled person is presented with the problem of providing alternative formulations with improved chemical stability.

Surprisingly, it has now been found that certain emulsions (which are not microemulsions) display dramatically improved chemical stability of trinexapac-ethyl.

Therefore, the present invention provides an emulsion comprising
(i) an aqueous phase comprising an agrochemical A; and
(ii) an oil phase comprising an agrochemical B;
   where either phase (i) is dispersed in phase (ii); or phase (ii) is dispersed in phase (i); agrochemical A is selected from salts of mepiquat and salts of chloromequat and mixtures of such salts; agrochemical B is trinexapac-ethyl; provided that the emulsion is not a microemulsion.

The emulsion may be stabilised by a soluble emulsifier; by solid particles; or by a combination of soluble emulsifier and solid particles.

When phase (i) is dispersed in phase (ii) the emulsion is a water-in-oil emulsion (EO); when phase (ii) is dispersed in phase (i) the emulsion is an oil-in-water emulsion (EW).

Suitably phase (ii) is dispersed in phase (i); the emulsion is an oil-in-water emulsion (EW).

Preferably, agrochemical A is selected from mepiquat chloride and chlormequat chloride; more preferably it is mepiquat chloride.

Agrochemical B is trinexapac-ethyl.

An emulsion is a dispersion of one liquid in a second liquid continuous phase, where the two liquids concerned are essentially immiscible, or have limited mutual miscibility. To form an emulsion, the two immiscible phases are mixed while supplying sufficient energy to cause one phase to break up into droplets dispersed in the second phase. The energy input may take different forms such as stirring, ultrasound or repeated forced flow through narrow orifices.

The basic factor in the stability or instability of an emulsion is the degree of interfacial tension (i.e. free energy) between the droplets of the dispersed liquid and the other continuous liquid phase.

By comparison, a microemulsion is a thermodynamically stable, isotropic liquid mixture of a water-immiscible organic solution, water and surfactant, wherein the microemulsion is formed spontaneously upon simple mixing of the components (WO2015/075646A1).

Due to a less favourable interfacial tension, oil-in-water (EW) and water-in-oil (EO) emulsions are thermodynamically unstable and will coalesce over time leading to phase separation. To slow down coalescence of the emulsion droplets, the emulsion droplets can be stabilised by adding emulsifiers. Such emulsifiers may be surfactants, polymers or solid particles, which adsorb at the liquid/liquid interface. Emulsifiers reduce the interfacial tension between the phases facilitating the formation of emulsion droplets. They also form a physical barrier, which prevents the emulsion droplets from coalescing.

Colloidal solids may stabilise dispersed emulsion droplets by adsorbing to the liquid-liquid interface (i.e. in the present invention it may further comprise solid particles at the interface between phase (i) and phase (ii)). Such emulsions are Pickering emulsions. The colloidal solids must be small enough so that they can coat the surface of the emulsion droplets. The colloidal solids must have sufficient affinity for both the liquids forming the dispersed and continuous phases such that they are able to adsorb to the liquid-liquid interface and thereby stabilise the emulsion. A wide variety of solid materials may be used as colloidal stabilizers for any Pickering emulsions of the present invention, including carbon black, metal oxides, metal hydroxides, metal carbonates, metal sulphates, polymers which are insoluble in any of the components present in the formulation, silica and clays. Colloidal clay particles may be crosslinked.

Specific examples of colloidal solids include zinc oxide, iron oxide, copper oxide, titanium oxide, aluminium oxide, calcium carbonate, precipitated silica and fumed silica, natural and synthetic clays such as attapulgite, kaolinite and Laponite®, as well as mixtures thereof. The colloidal solids may be surface modified, for example fumed or precipitated silica modified by the presence of dimethyldichlorosilane, hexadecylsilane or aluminium oxide or by alkane decoration.

Pickering emulsions may also comprise a de-flocculant (such as Sokalan® PA 30CL).

Cross-linked Pickering emulsions may also comprise retention aids (such as Pluronic® 6400).

Polymers suitable for use as colloidal stabilizers in the present invention include polymeric fibres, which have been modified so as to impart surface-active properties onto said fibres.

Surfactants are compounds which reduce the surface tension of water. Examples of surfactants are ionic (anionic, cationic or amphoteric) and nonionic surfactants. Surfactants can also be used as emulsifiers. Emulsions according to the invention typically comprise at least one surfactant (one, two, three or more surfactants).

Suitable ionic surfactants are the alkali, alkaline earth and ammonium salts of aromatic sulfonic acids, for example of lignosulfonic acid, phenolsulfonic acid, naphthalenesulfonic acid, dibutylnaphthalenesulfonic acid or of fatty acids, alkyl- and alkylarylsulfonates, alkylsulfates, lauryl ether sulfates and fatty alcohol sulfates, and salts of sulfated hexa-, hepta- and octa-decanols, and of fatty alcohol glycol ethers, condensates of sulfonated naphthalene and its derivatives with formaldehyde, condensates of naphthalene or of the naphthalenesulfonic acids with phenol and formaldehyde, polycarboxylates or phosphate esters of alkoxylated alcohols.

Suitable nonionic surfactants are polyoxyethylene octyl phenol ethers, alkoxylated alcohols such as ethoxylated isooctyl-, octyl- or nonyl-phenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors and also proteins, denatured proteins, polysaccharides (for example methylcellulose), hydrophobically modified starches, polyvinyl alcohols (for example Mowiol®), polyalkoxylates, polyvinylamines, polyethyleneimines, polyvinylpyrrolidones and their copolymers or block polymers.

Preferred non-ionic surfactant are polyvinyl alcohols. Particularly preferred are polyvinyl alcohols which have been prepared by saponification of polyvinyl acetate, with the degree of saponification being at least 60%, but preferably 80-95%. Suitable products of this kind are those commercially available under the registered trademark Mowiol®. A particularly preferred polyvinyl alcohol is Mowiol® 4-88 with a molecular weight of ca. 31,000Dalton, and a saponification degree of 86.7-88.7mo1%.

The oil phase comprises a liquid that does not substantially dissolve or become miscible with water. Examples of suitable oils for use as the oil phase include but are not limited to vegetable oils, methylated vegetable oils, aromatic oils and hydrocarbon solvents (for examples aromatics or aliphatic esters). The agrochemical B may itself be an oil or may be solubilised in a hydrophobic solvent to form an oil phase or may be dispersed in the oil phase or absorbed to the interface of the oil and aqueous phase of the present invention.

An emulsion of the present invention optionally contains an Ostwald ripening inhibitor. Ostwald ripening inhibitors suitable for use in the present invention are soluble or miscible in the dispersed phase, or themselves serve as the dispersed phase containing at least one active ingredient, which is substantially insoluble in the continuous phase, or having the active ingredient adsorbed to the liquid-liquid interface between the continuous phase and the dispersed phase as a colloidal solid. The Ostwald ripening inhibitors must have more affinity for the dispersed phase than the continuous phase. Suitable Ostwald ripening inhibitors for oil-in-water emulsions include solvents such as vegetable oils, methylated vegetable oils, mineral oils, liquid hydrocarbon solvents and polymers or oligomers with a molecular weight of at least 200 Dalton, preferably a molecular weight of at least 400 Dalton. Examples of suitable polymers are polymers and co-polymers of styrene, alkyl styrenes, isoprenes, butenes, butadienes, acrylonitriles, alkyl acrylates, alkyl methacrylates, vinyl chlorides, vinylidene chlorides and vinyl esters.

Polymeric co-stabilisers may be used in combination with colloidal solids to stabilise the emulsion droplets. Polymeric co-stabilisers useful in the present invention are water soluble polymers of sufficiently high molecular weight that they are soluble under certain conditions of pH, temperature or electrolyte concentration, and that they show a reduction in their solubility when one or more of these parameters is altered and that the reduction in solubility is sufficient to cause the flocculation of the solid colloidal particles. The solubility of the polymer can be controlled by pH sensitive groups, which may include but are not limited to polyethylene oxides or electrolyte dependent groups where the polymer becomes less soluble at high electrolyte strength, which may include but are not limited to polyacrylic acids and polyethylenes. Representative polymeric co-stabilizers include but are not limited to hydroxypropyl cellulose, hydroxymethylpropyl cellulose, hydroxyethyl cellulose, hydroxymethyl cellulose, acrylic graft polymers and polyvinyl alcohols.

Typically, Agrochemical B will be present in the emulsion at from 25 g/l to 150 g/l, suitably from 33 g/l to 100 g/l.

Typically, Agrochemical A will be present in the emulsion at from 200 g/l to 600 g/l, suitably from 225 g/l to 500 g/l.

Suitably trinexapac-ethyl is present in the emulsion at from 50 g/l to 100 g/l whilst mepiquat chloride is present in the emulsion at from 225 g/l to 450g/l. Suitably trinexapac-ethyl is present in the emulsion at from 33 g/l to 50 g/l whilst chlormequat chloride is present in the emulsion at from 400 to 600 g/l (preferably 500 g/l).

Generally any agrochemically active ingredient (Agrochemical A or Agrochemical B) will be present at a concentration of from about 0.000001% to about 90% w/w; preferably from about 0.001% to about 90% w/w. Agrochemical compositions of the invention may be in the form of a ready-to-use formulation or in concentrate form suitable for further dilution by the end user, and the concentrations of agrochemicals and the blend of (i) plus (ii) will be adjusted accordingly. In concentrated form, compositions of the invention typically contain, independently, Agrochemical A and Agrochemical B, each at from 1% to 90% w/w, more preferably from 2% to 75% w/w, even more preferably from 3% to 50% w/w, of the total composition.

The compositions of the present invention may relate to concentrates designed to be added to a farmer's spray tank of water or they may be applied directly without further dilution. The present invention also relates to compositions produced in a farmer's spray tank of water when a concentrate is mixed with water in the spray tank.

The compositions of the present invention may include other ingredients such as a viscosity modifier, an anti-foam agent, an anti-bacterial agent, a colourant or a perfume.

A composition of the present invention may be in the form of a ready mix emulsion formulation, packaged within a single vessel and ready to use directly after dilution.

The invention also contemplates capsule suspension formulations prepared by emulsion polymerisation.

Compositions of the present invention may be used in a method for regulating plant growth comprising applying to one or more plants an effective amount of the composition.

Compositions of the present invention may be used in a method for preventing and/or reducing lodging of crop plants comprising applying to one or more plants an effective amount of the composition.

Compositions of the present invention may be used in a method for enhancing roots system comprising applying to one or more plants an effective amount of the composition.

The above methods may involve one or more plants which are oilseed rape or monocotyledonous plants, preferably selected from cereals, rice, maize and sugar cane; more preferably the plants are cereal plants.

The above methods may involve an effective amount of the composition applied at a rate of from 0.5 to 5 l/ha, more suitably from 1 to 3 l/ha.

The following examples demonstrate the improved chemical stability associated with emulsions according to the present invention. Unless otherwise stated, all concentrations and ratios are by weight.

### EXAMPLE 1

This example provides emulsions, according to the present invention, comprising trinexapac-ethyl (at a concentration of 100 g/l) and chlormequat chloride (at a concentration of 450 g/l)).

Emulsion A: A 100 ml vessel was charged with chlormequat chloride (36.7 g) and water (27.4 g). The mixture was stirred with a paddle stirrer until the chlormequat chloride had completely dissolved. Imerys® RLO 7645 clay (8.0 g) was added and mixed in by stirring with a paddle stirrer. A 50% w/w solution of trinexapac-ethyl in Solvesso® 200ND (16.0 g) was mixed in with a Silverson® high-shear mixer (5000 rpm), while maintaining the temperature below 25° C. Within 10 minutes, a homogeneous emulsion had formed.

Emulsion B: A 100 ml vessel was charged with chlormequat chloride (36.7 g) and water (27.4 g). The mixture was stirred with a paddle stirrer until the chlormequat chloride had completely dissolved. A 20% w/w solution of Mowiol® 4-88 in water (8.1 g) was added. The mixture was homogenised by stirring with a paddle stirrer. A 50% w/w solution of trinexapac-ethyl in Solvesso® 200ND (16.0 g) was mixed in with a Silverson® high-shear mixer (5000 rpm), while maintaining the temperature below 25° C. Within 10 minutes, a homogeneous emulsion had formed.

### EXAMPLE 2

This example provides emulsions, according to the present invention, comprising trinexapac-ethyl (at a concentration of 100 g/l) and mepiquat chloride (at a concentration of 450 g/l)).

Emulsion C: A 380 ml vessel was charged with mepiquat chloride (114.2 g) and water (60.8 g). The mixture was stirred with a paddle stirrer until the mepiquat chloride had completely dissolved. Imerys® RLO 7645 clay (25.4 g) was mixed in using a paddle stirrer. The clay was dispersed for 5 minutes using a Silverson® high-shear mixer (5000 rpm), while maintaining the temperature below 25° C. A 50% w/w solution of trinexapac-ethyl in Solvesso®200ND (49.9 g) was added while continuing high-shear mixing (5000 rpm). After 5 minutes a homogeneous emulsion had formed. The concentration was adjusted by adding water (15.8 g). The formulation was homogenised by stirring with a paddle stirrer for 2 hours.

Emulsion D: A 250 ml vessel was charged with mepiquat chloride (68.9 g) and water (46.0 g). The mixture was stirred with a paddle stirrer until the mepiquat chloride had completely dissolved. A 20% w/w solution of Mowiol® 4-88 in water (15.1 g) was added and the mixture was stirred with a paddle stirrer for 10 minutes. A 50% w/w solution of trinexapac-ethyl in Solvesso® 200ND (30.1 g) was mixed in with a Silverson® high-shear mixer (5000 rpm), while maintaining the temperature below 25° C. After 10 minutes a homogeneous emulsion had formed.

### EXAMPLE 3

This is a Comparative Example.

Microemulsion E: A microemulsion comprising trinexapac-ethyl (at a concentration of 2.14% w/w) and chlormequat chloride (at a concentration of 25% w/w) was prepared in accordance with WO2015/075646A1, page 18, Table 1.

Solution F: Trinexapac-ethyl was molten at 50° C. before use. A 150 ml glass bottle was charged with mepiquat chloride (28.7 g), water (6.9 g), ethanol (69.1 g), and trinexapacethyl (6.6 g). The bottle was left on a roller for 16hours. In this time a homogeneous clear solution formed.

Solution G: Trinexapac-ethyl was molten at 50° C. before use. A 150 ml glass bottle was charged with mepiquat chloride (28.7 g), water (6.4 g), 1,2-propylene glycol (91.0 g), and trinexapac-ethyl (6.6 g). The bottle was left on a roller for 16hours. In this time a homogeneous clear solution formed.

### EXAMPLE 4

This example illustrates the stability of trinexapac-ethyl in the presence of chlormequat chloride.

Emulsions and a comparative microemulsion according to the above Examples were subjected to accelerated storage testing (2 weeks at 54° C.) whereby the chemical stability of trinexapac-ethyl was measured using standard analytical techniques; the concentration of trinexapac-ethyl remaining when compared to a reference sample stored at −18° C. is given, as a percentage, in Table 1 below, where the g/l concentrations of trinexapac-ethyl [TXP] plus chlormequat chloride [CCC] are given:

TABLE 1

| Formu- | Mixing | TXP::CCC | Formulation | TXP after |
|---|---|---|---|---|
| lation | Partner | (g/l) | Type | 2 weeks at 54° C. |
| E | Chlormequat | 20::235 | Microemulsion | 75% |
| | chloride | | | |
| A | Chlormequat | 100::450 | Pickering | 99% |
| | chloride | | Emulsion | |
| B | Chlormequat | 100::450 | Emulsion | 99% |
| | chloride | | | |

Trinexapac-ethyl was significantly more chemically stable within emulsion formulations according to the present invention than within a microemulsion.

### EXAMPLE 5

This example illustrates the stability of trinexapac-ethyl in the presence of mepiquat chloride.

Emulsions and comparative solutions according to the above Examples were subjected to accelerated storage testing (2 weeks at 54° C.) whereby the chemical stability of trinexapac-ethyl was measured using standard analytical techniques; the concentration of trinexapac-ethyl remaining when compared to a reference sample stored at −18° C. is given, as a percentage, in Table 2 below, where the g/l concentrations of trinexapac-ethyl [TXP] plus mepiquat chloride [MPQ] are given:

TABLE 2

| Formu- | Mixing | TXP::MPQ | Formulation | TXP after |
|---|---|---|---|---|
| lation | Partner | (g/l) | Type | 2 weeks at 54° C. |
| F | Mepiquat | 50::225 | Solution | 74% |
| | chloride | | | |
| G | Mepiquat | 50::225 | Solution | 77% |
| | chloride | | | |
| C | Mepiquat | 100::450 | Pickering | 99% |
| | chloride | | Emulsion | |
| D | Mepiquat | 100::450 | Emulsion | 98% |
| | chloride | | | |

Trinexapac-ethyl was significantly more chemically stable within emulsion formulations according to the present invention than within solutions.

1. An emulsion comprising
(i) an aqueous phase comprising an agrochemical A; and
(ii) an oil phase comprising an agrochemical B;
where either phase (i) is dispersed in phase (ii); or phase (ii) is dispersed in phase (i);
agrochemical A is selected from salts of mepiquat and salts of chlormequat and mixtures of such salts;
agrochemical B is trinexapac-ethyl;
provided that the emulsion is not a microemulsion.

2. An emulsion as claimed in claim 1 where phase (ii) is dispersed in phase (i).

3. An emulsion as claimed in claim 1 where agrochemical A is mepiquat chloride or chlormequat chloride.

4. A composition as claimed in claim 1 further comprising an emulsifier.

5. A composition as claimed in claim 1 further comprising solid particles at the interface between phase (i) and phase (ii).

6. A composition as claimed in claim 1 where concentration of agrochemical A is from 200 g/l to 600 g/l.

7. A composition as claimed in claim 1 where concentration of agrochemical B is from 25 g/l to 150 g/l.
